(19) United States
(12) Patent Application Publication
(10) Pub. No.: US 2007/0100110 A1
(43) Pub. Date: May 3, 2007

(54) Cross-linkable products based on organosilicon compounds

(75) Inventors: Uwe Scheim, Coswig (DE); Christian Ochs, Burghausen (DE); Gabriele Dineiger, Meissen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 10/596,681

(22) PCT Filed: Dec. 16, 2004
(86) PCT No.: PCT/EP04/14370

§ 371 Date: Jun. 21, 2006

(30) Foreign Application Priority Data
Dec. 22, 2003 (DE) 103 60 469.3

(51) Int. Cl. C08L 83/04; C08G 77/04; B32B 27/00

(52) U.S. Cl. 528/38; 524/863

(57) ABSTRACT

Crosslinkable organopolysiloxane compositions containing quaternary ammonium group-bearing organopolysiloxanes in minor amounts provide protection against microbial growth in moldings and sealants prepared therefrom.

The invention relates to crosslinkable materials based on organosilicon compounds having biostatic properties and a process for the preparation thereof and the use thereof.

One-component sealing compounds which are storable in the absence of water and vulcanize on admission of water at room temperature to give elastomers are known. These products are used in large amounts, for example in the construction industry. Particularly in environments having high atmospheric humidity, such as, for example, in bathrooms and kitchens, but, for example, also in tropical regions, organisms, such as fungi or algae, easily grow on the surface of the sealing compounds. In order to prevent this, biocides, such as, for example, fungicides, which prevent growth have to date been added to the sealing compounds. Examples of fungicides used in sealing compounds are methylbenzimidazol-2-yl carbamate (carbendazim), 10,10′-oxybisphenoxarsine, 2-(4-thiazolyl)benzimid-azole, N-octyl-4-isothiazolin-3-one, 4,5-dichloro-2-n-octyl-4-isothiazolin-3-one, diiodomethyl-p-tolyl sulfone (Amical, cf. for example EP 34 877 A), triazolyl compounds such as tebuconazole, in combination with silver-containing zeolites (cf. for example EP 931 811 A and EP 640 661 A) and benzothiophene-2-cyclohexylcarboxamide S,S-dioxide. However, these active substances have certain disadvantages, such as content of toxic heavy metals, chemical instability in some sealing material formulations or a tendency to discoloration. The biocides furthermore have the disadvantage that they must have a certain water solubility in order to be effective. This type of biocidal treatment is therefore effective only for a very limited time.

Moreover, these substances therefore slowly and completely enter the waste water.

The invention relates to crosslinkable materials based on organosilicon compounds, characterized in that they contain organosilicon compounds having quaternary ammonium groups.

The crosslinkable materials are preferably materials crosslinkable by condensation reaction.

In the context of the present invention, the designation “condensation reaction” is also intended to include an optionally preceding hydrolysis step.

Particularly preferably, the materials according to the invention are those containing
(A) organosilicon compound having at least two condensable groups,
(B) organosilicon compound having at least one unit of the formula
   —SiR²₂—R⁴—N⁺R³₂—R⁴—SiR²₂—X⁻ (II)
   in which
R² may be identical or different and has a meaning mentioned below for R,
R³ may be identical or different and is a monovalent, optionally substituted hydrocarbon radical or may be part of a bridging alkylene radical,
X⁻ is an organic or inorganic anion,
R⁴ is a divalent, optionally substituted hydrocarbon radical which may be interrupted by heteroatoms, and optionally
(C) a crosslinking agent.

In the context of the present invention, the designation “condensable” radicals is also understood as meaning those radicals which also include an optionally preceding hydrolysis step.

The condensable groups which may have the organosilicon compounds which are used and participate in the crosslinking reaction may be any desired groups, such as hydroxyl, acetoxy, oximato and organyloxy groups, in particular alkoxy radicals, such as ethoxy radicals, alkoxyethoxy radicals and methoxy radicals.

The organosilicon compounds (B) used according to the invention may be any desired organosilicon compounds having at least one radical of the formula (II), said compounds being both pure siloxanes, i.e. ≡Si—O—Si≡ structures, and silcarbanes, i.e. ≡Si—R′—Si≡ structures where R′ is a divalent hydrocarbon radical which is optionally substituted or is interrupted by heteroatoms, or copolymers having any desired organosilicon groups.

The organosilicon compounds (A) used according to the invention may be all organosilicon compounds having at least two condensable groups which have also been used to date in materials crosslinkable by condensation reaction. They may be both pure siloxanes, i.e. ≡Si—O—Si≡ structures, and silcarbanes, i.e. ≡—Si—R″—Si≡ structures where R″ is a divalent hydrocarbon radical which is optionally substituted or is interrupted by heteroatoms, or copolymers having any desired organosilicon groups.

The organosilicon compounds (A) used according to the invention are preferably those containing units of the formula
Rₐ(OR¹)_{b}Y_{c}SiO_{(4-a-b-c)/2} (I),
in which,
R may be identical or different and are optionally substituted hydrocarbon radicals which may be interrupted by oxygen atoms,
R¹ may be identical or different and are a hydrogen atom or monovalent, optionally substituted hydrocarbon radicals which may be interrupted by oxygen atoms,
Y may be identical or different and are a halogen atom or pseudohalogen radical, Si—N-bonded amine radicals, amide radicals, oxime radicals, aminoxy radicals and acyloxy radicals,
a is 0, 1, 2 or 3, preferably 1 or 2,
b is 0, 1, 2 or 3, preferably 0, 1 or 2, particularly preferably 0, and
c is 0, 1, 2 or 3, preferably 0 or 1, particularly preferably 0,
   with the proviso that the sum of a+b+c is less than or equal to 4 and at least two condensable radicals (OR¹) are present per molecule.

The sum a+b+c is preferably less than or equal to 3.

Radical R is preferably a monovalent hydrocarbon radical having 1 to 18 carbon atoms which is optionally substituted by halogen atoms, amino groups, ether groups, ester groups, epoxy groups, mercapto groups, cyano groups or (poly)glycol radicals, the latter being composed of oxyethylene and/or oxypropylene units, particularly preferably alkyl radicals having 1 to 12 carbon atoms, in particular the methyl radical. Radical R can, however, also be a divalent radical which links, for example, two silyl groups to one another.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl or tert-pentyl radical; hexyl radicals, such as the n-hexyl radical; heptyl radicals, such as the n-heptyl radical; octyl radicals, such as the n-octyl radical, and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl and cycloheptyl radical and methylcyclohexyl radicals; alkenyl radicals, such as the vinyl, 1-propenyl and 2-propenyl radical; aryl radicals, such as the phenyl, naphthyl, anthryl and phenanthryl radical; alkaryl radicals, such as o-, m- and p-tolyl radicals, xylyl radicals and ethylphenyl radicals; and aralkyl radicals, such as the benzyl radical, the α-and the β-phenylethyl radical.

Examples of substituted radicals R are the methoxyethyl, ethoxyethyl and ethoxyethoxyethyl radical. Examples of divalent radicals R are polyisobutylenediyl radicals and propanediyl-terminated polypropylene glycol radicals.

Examples of radicals R¹ are the monovalent radicals mentioned for R.

Radical R¹ is preferably a hydrogen atom or an alkyl radical having 1 to 12 carbon atoms, particularly preferably a hydrogen atom or methyl or ethyl radical, in particular a hydrogen atom.

Examples of radicals Y are acetoxy, dimethylamino, cyclohexylamino and methyl ethyl ketoximo radical, the acetoxy radical being preferred.

Organosilicon compounds (A) used according to the invention are particularly preferably those of the formula
(OR¹)_{3-f}R_{f}Si—(SiR₂—O)ₑ—SiR_{f}(OR¹)_{3-f} (IV),
in which
R and R′have the abovementioned meanings,
e is from 30 to 3000 and
f is 1 or 2.

f is preferably 2 if R¹ has the meaning of a hydrogen atom, and f is 1 if R¹ has a meaning other than a hydrogen atom.

Examples of organosilicon compounds (A) are
(MEO)₂MeSiO [SiMe₂O]₂₀₀₋₂₀₀₀SiMe (OMe)₂,
(HO)Me₂SiO [SiMe₂O]₂₀₀₋₂₀₀₀SiMe₂(OH),
(EtO)₂MeSiO [SiMe₂O]₂₀₀₋₂₀₀₀SiMe(OEt)₂,
(HO)MeViSiO [SiMe₂O]₂₀₀₋₂₀₀₀SiMeVi(OH),
(MeO)₂ViSiO[SiMe₂O]₂₀₀₋₂₀₀₀SiVi(OMe)₂ and
(EtO)₂ViSiO [SiMe₂O]₂₀₀₋₂₀₀₀SiVi(OEt)₂,
   Me being a methyl radical, Et being an ethyl radical and Vi being a vinyl radical.

The organosilicon compounds (A) used according to the invention have a viscosity of preferably from 100 to 10⁶ mPa.s, particularly preferably from 10³ to 350 000 mPa.s, in each case at 25° C.

The organosilicon compounds (A) are commercially available products and can be prepared by methods customary in silicon chemistry.

Examples of radicals R² are the monovalent examples mentioned for radical R.

Radical R² is preferably a hydrocarbon radical having 1 to 18 carbon atoms which is optionally substituted by halogen atoms, amino groups, ether groups, ester groups, epoxy groups, mercapto groups, cyano groups or (poly)glycol radicals, the latter being composed of oxyethylene and/or oxypropylene units, particularly preferably alkyl radicals having 1 to 12 carbon atoms, in particular the methyl radical.

Examples of radicals R³ are the monovalent examples mentioned for radical R and divalent optionally substituted hydrocarbon radicals having 1 to 30 carbon atoms.

Radical R³ is preferably a hydrocarbon radical having 1 to 8 carbon atoms, particularly preferably an alkyl radical having 1 to 6 carbon atoms and a benzyl radical. Radical R³ can, however, also be a divalent radical derived therefrom, so that, for example, two radicals R³ form a ring with the nitrogen atom.

Examples of anion X⁻ are organic anions, such as carboxylate ions, enolate ions and sulfonate ions, and inorganic anions, such as halide ions, such as, for example, fluoride ions, chloride ions, bromide ions and iodide ions, and sulfate ions.

Anion X− is particularly preferably a carboxylate ion and a halide ion, particularly preferably a chloride ion and acetate ion.

Examples of radicals R⁴ are divalent linear, cyclic or branched, saturated or unsaturated hydrocarbon radicals which are interrupted by one or more oxygen atoms, such as all alkylene radicals, arylene radicals, 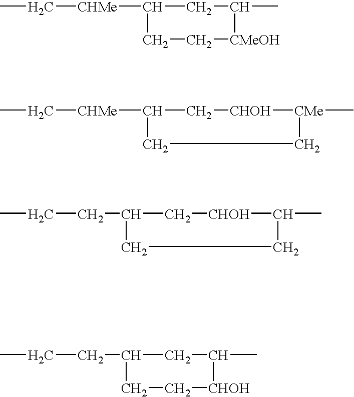
—(CH₂)₃OCH₂—CH(OH)—CH₂— and —(CH₂)₃OCH₂—CH[—CH₂(OH)]—, Me being the methyl radical.

Radical R⁴ is preferably an alkylene radical and —(CH₂)₃OCH₂—CH(OH)—CH₂— and —(CH₂)₃OCH₂—CH[—CH₂(OH)]—, particularly preferably —(CH₂)₃OCH₂—CH(OH)—CH₂— and —(CH₂)₃OCH₂—CH[—CH₂(OH)]—.

The organosilicon compounds (B) used according to the invention are preferably those of the formula
D¹-(R⁴SiR²₂)ₕ13 [(OSiR²₂)_{d}—R⁴—N⁺R³₂—R⁴—SiR²₂]ₙ-D²·nX⁻ (III),
in which
D¹ is a hydrogen atom, hydroxyl radical or halide radical, a radical —NR*₂ or a monovalent organic radical, it being possible for R* to be identical or different and R* being a hydrogen atom or a monovalent, optionally substituted hydrocarbon radical and it also being possible for the radical —NR*₂to be present as an ammonium salt, and
D² is a group of the formula —(OSiR²₂)_{g—R}⁴ₖ-D¹, where
R², R³, D¹, X⁻ and R⁴ have a meaning mentioned above therefor, it being possible for the two radicals D¹ in each polymer molecule of the formula (III) to be identical or different, and
d is an integer from 1 to 200,
h is 0 or 1,
k is 0 or 1,
g is a number from 0 to 1000 and
n is an integer from 1 to 50.

Examples of halide radical D¹ are —Cl and —Br and an example of the radical —NR*₂ is the —N(CH₃)₂ radical.

Particularly preferably, the organosilicon compounds (B) used according to the invention are polymers of the formula (III) where R⁴ are alkylene radicals having at least 4 carbon atoms and at least one hydroxyl group, —(CH₂)₃OCH₂—CH(OH)—CH₂— and —(CH₂)₃OCH₂—CH[—CH₂(OH)]—, particularly preferably —(CH₂)₃OCH₂—CH(OH)—CH₂— and —(CH₂)₃OCH₂—CH[CH₂(OH)]—.

Examples of the organosilicon compounds (B) used according to the invention are
D¹[(OSi(CH₃)₂—(CH₂)₃OCH₂CH(OH)CH₂—N⁺(CH₃)₂—CH₂CH(OH) CH₂O(CH₂)₃—Si(CH₃)₂]ₙ-D².nCl⁻
   where D¹=H, D²=OH and n=about 20, 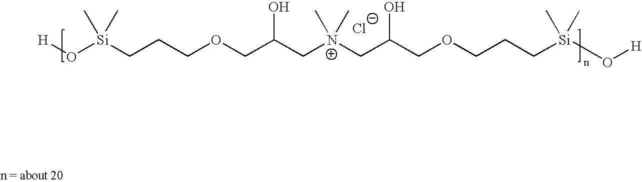
D¹[OSi(CH₃)₂—(CH₂)₃OCH₂CH(OH)CH₂—N+(CH₃)₂—CH₂CH(OH)CH₂O (CH₂)₃—Si(CH₃)₂]-D².nCl⁻
   where D¹=H, D²=OSi(CH₃)₂—(CH₂)₃OCH₂CH(OH)CH₂N(CH₃)₂and n=about 20, 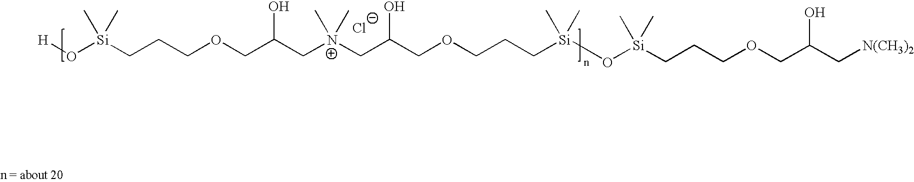
D¹[(OSi(CH₃)₂)_{d}—(CH₂)₃OCH₂CH(OH)CH₂—N+(CH₃)₂—CH₂CH(OH)CH₂O (CH₂)₃—Si(CH₃)₂]ₙ-D².nCl⁻
   where D¹=H, D²=—(OSi(CH₃)₂)_{g}—(CH₂)₃OCH₂CH(OH) CH₂N(CH₃)₂, n=about 20, d=g=5-10 or d=g 32 30-60, 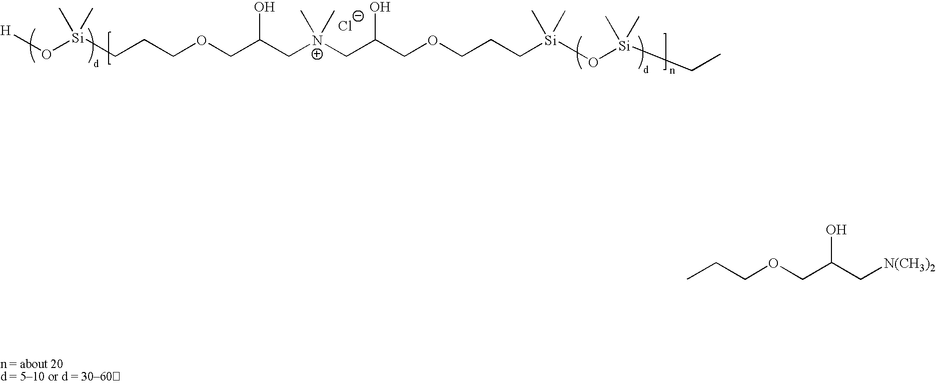
D¹-CH₂CH(OH)CH₂O(CH₂)₃Si(CH₃)₂—[OSi(CH₃)₂—(CH₂)₃OCH₂CH(OH)CH—N⁺(CH₃)₂—CH₂CH(OH)CH₂O(CH₂)₃—Si(CH₃)₂]ₙ-D².nCl⁻
   where D¹=Cl, D²=—OSi(CH₃)₂(CH₂)₃OCH₂CH(OH)CH₂—N(CH₃)₂and n=about 20, 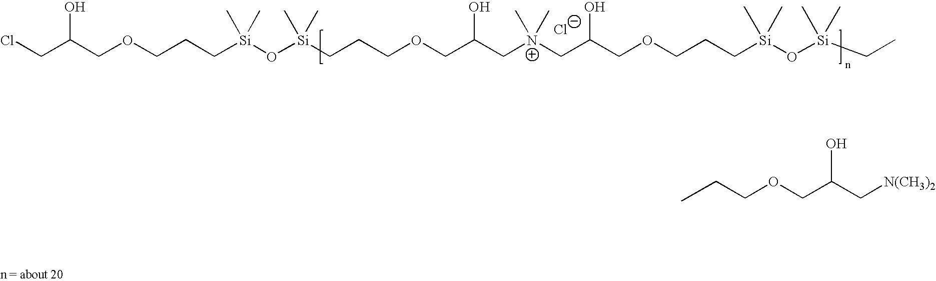
D¹-CH₂CH(OH)CH₂O(CH₂)₃Si(CH₃)₂—[(OSi(CH₃)₂)_{d}—(CH₂)₃OCH₂CH(OH)CH—N⁺(CH₃)₂—CH₂CH(OH)CH₂O(CH₂)₃—Si(CH₃)₂]ₙ-D².nCl⁻
   where D¹=(CH₃)₂N—, D²=(OSi(CH₃)₂)_{g}(CH₂)₃OCH₂CH(OH)CH₂—N(CH₃)₂, n =about 20 and d=g=5-10 or d=g=30-60,

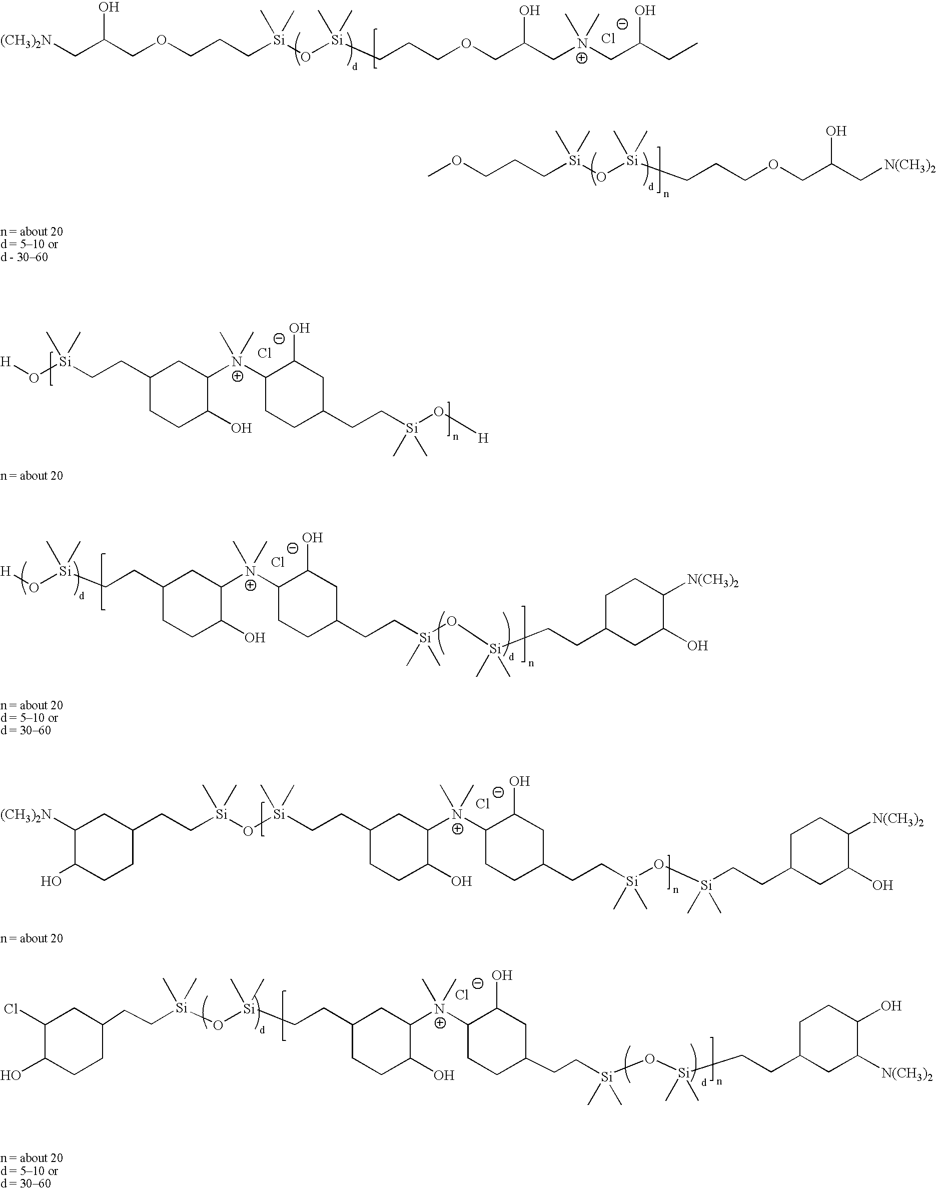

it being possible for the Cl and —N(CH₃)₂ substituents on the cyclohexyl radical, independently of one 5 another, to occupy not only the 4-position but also the 3-position relative to the —CH₂CH₂— group and the data for the indices n and d being understood as average values for polymeric compounds having a very broad molar mass distribution.

The organosilicon compounds (B) used according to the invention have a viscosity of preferably from 10⁴ to 10⁸ mPa.s, particularly preferably from 10⁵ to 5·10⁷ mPa.s, in each case at 25° C.

The organosilicon compounds (B) used according to the invention are commercially available products or can be prepared by known processes, such as, for example, by reacting the corresponding epoxy-functional silanes and/or siloxanes with dialkylammonium salts, such as, for example, dimethylammonium chloride, or by reacting the corresponding amino compounds with alkyl halides.

The crosslinking agents (C) optionally used in the materials according to the invention may be any desired crosslinking agents known to date which have at least three condensable radicals, such as, for example, silanes or siloxanes having at least three organyloxy groups.

The crosslinking agents (C) optionally used in the materials according to the invention are preferably organosilicon compounds of the formula
(R⁶O)ₖZ₁,SiR⁵₍₄₋ₖ₋₁₎ (V),
in which
R⁵ may be identical or different and are monovalent, optionally substituted hydrocarbon radicals which may be interrupted by oxygen atoms,
R⁶ may be identical or different and has a meaning mentioned above for R¹,
Z may be identical or different and has a meaning stated above for Y,
k is 0, 1, 2, 3 or 4, preferably 2 or 3, particularly preferably 3 and
l is 0, 1, 2, 3, or 4, preferably 0 or 3, particularly preferably 0,
   with the proviso that the sum k+l is 3 or 4, and the partial hydrolysis products thereof.

The partial hydrolysis products may be partial homogeneous hydrolysis products, i.e. partial hydrolysis products of one type of organosilicon compound of the formula (V), as well as partial heterogeneous hydrolysis products, i.e. partial hydrolysis products of at least two different types of organosilicon compounds of the formula (V).

If the crosslinking agents (C) optionally used in the materials according to the invention are partial hydrolysis products of organosilicon compounds for the formula (V) those having up to 6 silicon atoms are preferred.

Examples of radical R⁶ are the examples mentioned above for radical R¹. Radical R⁶ is preferably a hydrogen atom and alkyl radicals, particularly preferably a hydrogen atom and alkyl radicals having 1 to 4 carbon atoms, in particular a hydrogen atom and the methyl and the ethyl radical.

Examples of radical R⁵ are the monovalent examples mentioned above for radical R, hydrocarbon radicals having 1 to 12 carbon atoms being preferred and the methyl and the vinyl radical being particularly preferred.

Examples of Z are the examples stated for Y, acetoxy radicals and methyl ethyl ketoximo radicals being preferred.

The crosslinking agents (C) optionally used in the materials according to the invention are particularly preferably tetramethoxysilane, tetraethoxysilane, tetrapropoxysilane, tetrabutoxysilane, methyltrimethoxysilane, methyltriethoxysilane, vinyltrimethoxysilane, vinyltriethoxysilane, phenyltrimethoxysilane, phenyltriethoxysilane, 3-cyanopropyltrimethoxysilane, 3-cyanopropyltriethoxysilane, 3-(glycidyloxy)propyltriethoxysilane, 1,2-bis(trimethoxysilyl)ethane, 1,2-bis(triethoxysilyl)ethane, 3-aminopropyltrimethoxysilane, 3-(2-aminoethyl)aminopropyltrimethoxysilane, 3-(2-aminoethyl)aminopropylmethyldimethoxysilane, cyclohexylaminomethyltriethoxysilane, methyltriacetoxysilane, ethyltriacetoxysilane, methyltris(methylethylketoximo)silane, vinyltris(methylethylketoximo)silane and partial hydrolysis products of said organosilicon compounds, such as, for example, hexaethoxydisiloxane.

The crosslinking agents (C) optionally used in the materials according to the invention are commercially available products or can be prepared by processes known in silicon chemistry.

If the materials according to the invention contain crosslinking agents (C) they do so in amounts of preferably from 0.01 to 20 parts by weight, particularly preferably from 0.5 to 10 parts by weight, in particular from 1.0 to 5.0 parts by weight, based in each case on 100 parts by weight of organopolysiloxane (A).

In addition to the components (A), (B) and (C) described above, the materials according to the invention may now contain all further substances which have also been used to date in materials crosslinkable by condensation reaction, such as, for example, catalysts (D), plasticizer (E), fillers (F), adhesion promoter (G) and additives (H).

Examples of catalysts (D) are the titanium compounds and organic tin compounds already known to date, such as di-n-butyltin dilaurate and di-n-butyltin diacetate, di-n-butyltin oxide, dioctyltin diacetate, dioctyltin dilaurate, dioctyltin oxide and reaction products of these compounds with alkoxysilanes, such as tetraethoxysilane, where di-n-butyltin diacetate and dibutyltin oxide in tetraethyl silicate hydrolysis product being preferred and di-n-butyltin oxide in tetraethyl silicate hydrolysis product being particularly preferred.

If the materials according to the invention contain catalyst (D) they do so in amounts of preferably from 0.01 to 3 parts by weight, preferably from 0.05 to 2 parts by weight, based in each case on 100 parts by weight of constituent (A).

Examples of plasticizer (E) are dimethylpolysiloxanes which are liquid at room temperature and endcapped by trimethylsilyloxy groups, in particular having viscosities at 25° C. in the range from 50 to 1000 mPa.s, and high-boiling hydrocarbons, such as, for example, liquid paraffins or mineral oils consisting of naphthenic and paraffinic units.

The materials according to the invention contain plasticizer (E) in amounts of preferably from 0 to 300 parts by weight, particularly preferably from 10 to 200 parts by weight, in particular from 20 to 100 parts by weight, based in each case on 100 parts by weight of organopolysiloxane (A).

Examples of fillers (F) are unreinforced fillers, i.e. fillers having a BET surface area of up to 50 m²/g, such as quartz, diatomaceous earth, calcium silicate, zirconium silicate, zeolites, metal oxide powders, such as aluminum, titanium, iron or zinc oxides and mixed oxides thereof, barium sulfate, calcium carbonate, gypsum, silicon nitride, silicon carbide, boron nitride, glass and plastic powders, such as polyacrylonitrile powder; reinforcing fillers, i.e. fillers having a BET surface area of more than 50 m²/g, such as pyrogenically prepared silica, precipitated silica, precipitated chalk, carbon black, such as furnace black and acetylene black, and silicon-aluminum mixed oxides of large BET surface areas; fibrous fillers, such as asbestos and plastic fibers. Said fillers may have been rendered hydrophobic, for example by the treatment with organosilanes or organosiloxanes or with stearic acid or by etherification of hydroxyl groups to alkoxy groups. If fillers (F) are used, they are preferably hydrophilic pyrogenic silica and precipitated or ground calcium carbonate.

The materials according to the invention contain fillers (F) in amounts of preferably from 0 to 300 parts by weight, particularly preferably from 1 to 200 parts by weight, in particular from 5 to 200 parts by weight, based in each case on 100 parts by weight of organopolysiloxane (A).

Examples of the adhesion promoters (G) used in the materials according to the invention are silanes and organopolysiloxanes having functional groups, such as, for example, those having glycidyloxypropyl or methacryloyloxypropyl radicals, and tetraalkoxysilanes. If, however, another component, such as, for example, siloxanes (A) or crosslinking agent (C) already has said functional groups, it is possible to dispense with an addition of adhesion promoter.

The materials used according to the invention contain adhesion promoter (G) in amounts of preferably from 0 to 50 parts by weight, particularly preferably from 1 to 20 parts by weight, in particular from 1 to 10 parts by weight, based in each case on 100 parts by weight of organopolysiloxane (A).

Examples of additives (H) are pigments, dyes, fragrances, antioxidants, agents for influencing the electrical properties, such as conductive carbon black, flame-retardant agents, light stabilizers and agents for increasing the skin formation time, such as silanes having an SiC-bonded mercaptoalkyl radical, cell-producing agents, e.g. azodicarbonamide, heat stabilizers and thixotropic agents, such as, for example, phosphoric acid esters, and organic solvents, such as alkylaromatics.

The materials according to the invention contain additives (H) in amounts of preferably from 0 to 100 parts by weight, particularly preferably from 0 to 30 parts by weight, in particular from 0 to 10 parts by weight, based in each case on 100 parts by weight of organopolysiloxane (A).

Particularly preferably, the materials according to the invention are those which consist of
(A) organosilicon compounds containing units of the formula (I),
(B) organosilicon compound having at least one unit of the formula (II), optionally
(C) crosslinking agent of the formula (V), optionally
(D) catalyst, optionally
(E) plasticizer, optionally
(F) fillers, optionally
(G) adhesion promoter and optionally
(H) additives.

For preparing the materials according to the invention, all constituents can be mixed in any desired sequence with one another. This mixing can be effected at room temperature and the pressure of the ambient atmosphere, i.e. from about 900 to 1100 hPa. If desired, however, this mixing can also be effected at higher temperatures, for example at temperatures in the range from 35° C. to 135° C.

The individual constituents of the materials according to the invention may in each case be one type of such a constituent as well as a mixture of at least two different types of such constituents. For the crosslinking of the materials according to the invention, the usual water content of the air is sufficient. The crosslinking of the materials according to the invention is preferably effected at room temperature. It can, if desired, also be carried out at temperatures higher or lower than room temperature, e.g. at from −50° to 15° C. or at from 30° to 50° C., and/or by means of water concentrations exceeding the normal water content of the air. The crosslinking is preferably carried out at a pressure from 100 to 1100 hPa, in particular at the pressure of the ambient atmosphere.

The present invention furthermore relates to moldings produced by crosslinking the materials according to the invention.

The materials according to the invention can be used for all purposes for which it is possible to use materials which are storable in the absence of water and crosslinked to give elastomers on admission of water at room temperature.

The materials according to the invention are therefore suitable in an excellent manner, for example, as sealing compounds for joints, including perpendicular joints, and similar empty spaces having an internal dimension of from 10 to 40 mm, for example of buildings, land and water vehicles and aircraft, or as adhesives or cementing materials, for example in window construction or in the production of aquaria or glass cabinets, and, for example, for the production of protective coatings, including those for surfaces exposed to the constant action of fresh or sea water, or antifriction coatings, or of elastomeric moldings and for the insulation of electrical or electronic apparatuses.

The materials according to the invention have the advantage that they can be easily prepared and exhibit a biocidal action over a long period.

Furthermore, the materials according to the invention have the advantage that, owing to the biocidal treatment, the tendency of both the still uncured material and the cured moldings to become discolored is extremely low.

The crosslinkable materials according to the invention have the advantage that they are distinguished by a very long shelf life and a high crosslinking rate.

In the examples described below, all viscosity data are based on a temperature of 25° C. Unless stated otherwise, the following examples are carried out at a pressure of the ambient atmosphere, i.e. at about 1000 hPa, and at room temperature, i.e. at about 23° C., or at a temperature which is established on combining the reactants at room temperature without additional heating or cooling, and at a relative humidity of about 50%. Furthermore, all data relating to parts and percentages are based on weight, unless stated otherwise.

### EXAMPLE 1

Preparation of a polyquaternary polysiloxane: 286.4 g of dimethylammonium chloride were dissolved in 1000 ml of water, 1200 g of 1,3-bis(3-glycidyloxypropyl)-1,1,3,3-tetramethyldisiloxane were added and the mixture was refluxed with thorough stirring. The reaction mixture was stirred for 2 hours at 105-110° C., the reaction batch changing from colorless and turbid to clear yellow. The solvent was then removed in vacuo at 120° C. The reaction product was a dark yellow, highly viscous oil having a viscosity of about 16·10⁶ mPa.s. The ¹H-NMR spectroscopic investigation showed the formation of a polyquaternary polysiloxane having about on average 18 to 20 repeating units corresponding to the formula

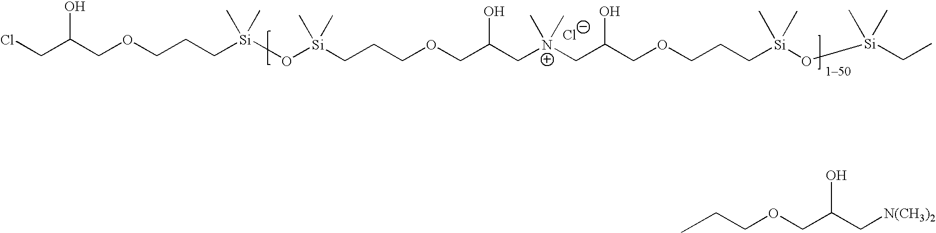

In a planetary mixer with vacuum equipment, 1400 g of a polydimethylsiloxane having —OSi(OCH₃)₂(CH₃) terminal groups and possessing a viscosity of 80 000 mPa.s are mixed with 600 g of a polydimethylsiloxane having —OSi(CH₃)₃ terminal groups and a viscosity of 100 mPa.s, 12 g of the polyquaternary polysiloxane whose preparation is described above, 100 g of methyltrimethoxysilane, 2.5 g of octylphosphonic acid and 18 g of 3-aminopropyltrimethoxysilane in the absence of water. 200 g of pyrogenic hydrophilic silica having a specific surface area of 150 m²/g are then mixed in. After the mixture is homogeneous and has been freed from included air by evacuation, 10 g of a tin catalyst (reaction product which was prepared from 4 parts of tetraethoxysilane with 2.2 parts of dibutyltin diacetate) are also mixed in. After further homogenization in vacuo, the mixture is introduced into moisture-tight containers.

2 mm thick test specimens are produced with the material thus obtained by spreading the material on a polyethylene substrate and storing it for 14 days at 50% relative humidity and 23° C.

Test specimens according to DIN EN ISO 846 are produced from the vulcanisate sheets thus produced and are tested by method B as described in the standard. The results are shown in table 1.

For determining the shelf life, a sample was stored for 3 days at 100° C. in a container which was tight to atmospheric humidity. There were no changes with regard to curing behavior and appearance of the sample, which shows an excellent shelf life and resistance to yellowing.

### EXAMPLE 2

1400 g of an α,ω-dihydroxypolydimethylsiloxane having a viscosity of 80 000 mPa.s, 12 g of the polyquaternary polysiloxane whose preparation is described in example 1, 300 g of a polydimethylsiloxane having —OSi(CH₃)₃ terminal groups and a viscosity of 100 mPa.s, 300 g of a hydrocarbon mixture having a kinematic viscosity of 6.2 mm²/s (at 40° C.), a viscosity-density constant (VDC) of 0.79 and a boiling range of from 300° C. to 370° C. (carbon distribution: 62% of paraffinic, 38% of naphthenic and 0.03% of aromatic carbon atoms), 90 g of ethyltriacetoxysilane and 190 g of a pyrogenic hydrophilic silica having a specific surface area of 150 m²/g are homogeneously mixed in a planetary mixer in vacuo. 0.5 g of dibutyltin diacetate was then added and homogenization was effected again for 5 minutes.

Test specimens are produced as described in example 1 from the material thus obtained and are tested according to DIN EN ISO 846. The results are shown in table 1.

For determining the shelf life, a sample was stored for 3 days at 100° C. in a container tight to atmospheric humidity. There were no changes with regard to curing behavior and appearance of the sample, which shows an excellent shelf life and resistance to yellowing.

### EXAMPLE 3

The procedure described in example 1 is repeated, except that twice the amount of the polyquaternary polysiloxane was used.

Test specimens are produced as described in example 1 from the material thus obtained and are tested according to DIN EN ISO 846. The results are shown in table 1.

For determining the shelf life, a sample was stored for 3 days at 100° C. in a container tight to atmospheric humidity. There were no changes with regard to curing behavior and appearance of the sample, which shows an excellent shelf life and resistance to yellowing.

### EXAMPLE 4

233 g of dimethylammonium chloride were dissolved in 1700 ml of water. 2238 g of a polysiloxane consisting of (3-glycidyloxypropyl)dimethylsilyloxy and dimethylsilyloxy units having on average 8 silicon atoms and an epoxy group content of 2.4 mmol/g are added to the solution, and the mixture is refluxed with through stirring. The reaction mixture was stirred for 6 hours at 105-110° C., the reaction batch changing from colorless and turbid to clear yellow. The solvent was then removed in vacuo at 120° C. The reaction product was a dark yellow, highly viscous oil having a viscosity of about 6-10⁶ mPa.s. The 1H-NMR spectroscopic investigation showed the formation of a polyquaternary polysiloxane having on average about 30 to 35 repeating units corresponding to the formula

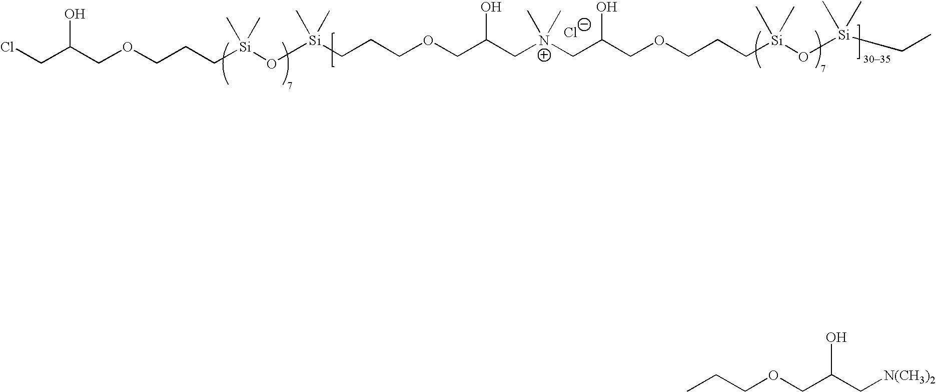

35 g of the polyquaternary polysiloxane thus prepared, 1400 g of an α,ω-dihydroxypolydimethylsiloxane having a viscosity of 80 000 mPa.s, 600 g of a polydimethylsiloxane having —OSi(CH₃)₃ terminal groups and a viscosity of 100 mpa.s, 90 g of ethyltriacetoxysilane and 190 g of a pyrogenic hydrophilic silica having a specific surface area of 150 m²/g were homogeneously mixed in a planetary mixer in vacuo. 0.5 g of dibutyltin diacetate was then added and homogenization was effected again for 5 minutes.

Test specimens are produced as described in example 1 from the material thus obtained and are tested according to DIN EN ISO 846. The results are shown in table 1.

For determining the shelf life, a sample was stored for 3 days at 100° C. in a container tight to atmospheric humidity. There were no changes with regard to curing behavior and appearance of the sample, which shows an excellent shelf life and resistance to yellowing.

TABLE 1

| | Fungi | | | | |
|---|---|---|---|---|---|
| | A | B | C | D | E |
| Example 1 | 1 | 0 | 0 | 0 | 2 |
| Example 2 | 2 | 1 | 2 | 2 | 4 |
| Example 3 | 2 | 00 | 00 | 00 | 1 |
| Example 4 | 2 | 1 | 1 | 1 | 2 |

A = Aspergillus niger
B = Penicillium funiculosum
C = Paecillomyces variotii
D = Gliocladium virens
E = Chaetomium globosum
00 no growth detectable on microscopic examination, formation of an inhibitory zone around the test specimen
0 no growth detectable on microscopic examination
1 no growth visible to the naked eye but clearly detectable under the microscope
2 growth detectable with the naked eye, up to 25% of the sample surface covered with growth
3 growth detectable with the naked eye, up to 50% of the sample surface covered with growth
4 considerable growth, over 50% of the sample surface covered with growth
5 strong growth, entire sample surface covered with growth.

1-9. (canceled)

10. A crosslinkable material comprising
(A) at least one organosilicon compound having at least two condensable groups,
(B) at least one organosilicon compound having at least one unit of the formula
—SiR²₂—R⁴—N⁺R³₂—R⁴—SiR²₂—.X⁻ (II),
in which
R² are identical or different and have the meaning stated below for R,
R³ are identical or different and are a monovalent, optionally substituted hydrocarbon radical or are part of a bridging alkylene radical,
X⁻ is an organic or inorganic anion,
R⁴ is a divalent, optionally substituted hydrocarbon radical optionally interrupted by heteroatoms, and
(C) optionally a crosslinking agent.

11. The crosslinkable material of claim 10 wherein organosilicon compounds
(A) comprise those containing units of the formula
R_{a(OR}¹⁾_{b}Y_{c}SiO_{(4-a-b-c)/2} (I),
in which
R are identical or different and are optionally substituted hydrocarbon radicals optionally interrupted by oxygen atoms,
R¹ are identical or different and are a hydrogen atom or monovalent, optionally substituted hydrocarbon radical optionally interrupted by oxygen atoms,
Y are identical or different and are a halogen atom or pseudohalogen radical, Si—N-bonded amine radical, amide radical, oxime radical, aminoxy radical, or acyloxy radical,
a is 0, 1, 2 or 3,
b is 0, 1, 2 or 3, and
c is 0, 1, 2 or 3,
with the proviso that the sum of a+b+c is less than or equal to 4 and at least two condensable radicals (OR¹) are present per molecule.

12. The crosslinkable material of claim 10, wherein at least one organosilicon compound (B) is one of the formula
D¹-(R⁴SiR²₂)ₕ—[(OSiR²₂)_{d}—R⁴—N⁺R³₂—⁴—SiR²₂]ₙ-D²·nX⁻ (III),
in which
D¹ is a hydrogen atom, hydroxyl radical, or halide radical, a radical —NR*₂ or a monovalent organic radical, R* being identical or different and being a hydrogen atom or a monovalent, optionally substituted hydrocarbon radical, the radical —NR*₂ optionally present as an ammonium salt, and
D² is a group of the formula —(OSiR²₂)_{g}—R⁴ₖ-D¹, where
R², R³, D¹, X⁻ and R⁴ have the meanings stated above therefor, the radicals D¹ in each polymer molecule of the formula (III) being identical or different, and
d is an integer from 1 to 200,
h is 0 or 1,
k is 0 or 1,
g is a number from 0 to 1000 and
n is an integer from 1 to 50.

13. The crosslinkable material of claim 10, wherein organosilicon compounds (B) have a viscosity of from 10⁴ to 10⁸ mPa.s at 25° C.

14. The crosslinkable material of claim 10, wherein at last one organosilicon compound (A) is one of the formula
(OR¹)_{3-f}R_{f}Si—(SiR₂—O)ₑ—SiR_{f}(OR¹)_{3-f} (IV),
in which
R and R¹ have the abovementioned meanings,
e is from 30 to 3000 and
f is 1 or 2.

15. The crosslinkable material of claim 11, consisting essentially of:
(A) at least one organosilicon compound containing units of the formula (I),
(B) at least one organosilicon compound having at least one unit of the formula (II),
(C) one or more crosslinking agents of the formula (V), optionally
(D) a condensation catalyst,
(E) optionally, a plasticizer,
(F) optionally, one or more fillers, and
(G) optionally, one or more adhesion promoter.

16. The crosslinkable material of claim 14, consisting essentially of:
(A) organosilicon compounds of the formula (IV),
(B) organosilicon compound of the formula (III),
(C) optionally crosslinking agent(s) of the formula (V),
(D) optionally, a catalyst,
(E) optionally, a plasticizer,
(F) optionally fillers, and
(G) optionally, an adhesion promoter.

17. A molding produced by crosslinking the crosslinkable material of claim 10.
